(19) United States
(12) Patent Application Publication
(10) Pub. No.: US 2008/0010510 A1
(43) Pub. Date: Jan. 10, 2008

(54) METHOD AND SYSTEM FOR USING MULTIPLE MEMORY REGIONS FOR REDUNDANT REMAPPING

(76) Inventors: Tony Turner, Rancho Santa Margarita, CA (US); Mihai Lupu, San Diego, CA (US); Iue-Shuenn Chen, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/567,299

(22) Filed: Dec. 6, 2006

Related U.S. Application Data
(60) Provisional application No. 60/814,833, filed on Jun. 19, 2006.

(51) Int. Cl. G06F 11/00

(52) U.S. Cl. 714/8

(57) ABSTRACT

Certain aspects of a method and system for using multiple memory regions for redundant remapping are disclosed. Aspects of one method may include dividing at least a portion of on-chip memory into a plurality of memory regions. Each of the plurality of memory regions may be mapped into a corresponding plurality of redundant memory regions, wherein if an error is detected in at least one of the plurality of memory regions, at least one of the plurality of memory regions having the detected error may be remapped to at least one of the corresponding plurality of redundant memory regions.

### CROSS-REFERENCE TO RELATED APPLICATIONS/INCORPORATION BY REFERENCE

This patent application makes reference to, claims priority to and claims benefit from U.S. Provisional Patent Application Ser. No. 60/814,833, filed on Jun. 19, 2006.

The above referenced application is hereby incorporated herein by reference in its entirety.

### FIELD OF THE INVENTION

Certain embodiments of the invention relate to secure communication systems. More specifically, certain embodiments of the invention relate to a method and system for using multiple memory regions for redundant remapping.

### BACKGROUND OF THE INVENTION

In an increasingly security conscious world, protecting access to information and/or to systems from unwanted discovery and/or corruption is a major issue for both consumers and businesses. Many consumer or business systems may be vulnerable to unwanted access when the level of security provided within the system is not sufficient for providing the appropriate protection. In this regard, consumer systems, such as multimedia systems, for example, may require the use of integrated architectures that enable security management mechanisms for defining and administering user rights or privileges in order to provide the necessary protection from unwanted access.

An example of a multimedia system that may be accessed by many different users may be a set-top box where manufacturers, vendors, operators, and/or home users may have an interest in accessing or restricting at least some limited functionality of the system. In some instances, a single device, such as a security processor for example, may be utilized to administer security operations in the multimedia system. The security processor may operate independently of other components in the multimedia system when determining rights or privileges of different users to various features in the multimedia system. For example, vendors may have limited access to some of the functions that may be accessible by the manufacturer. Home users may only have access to a subset of the vendors' access rights. In some instances, secure operations may be managed by specifying, in a single location, secure conditions for each security component supported by the system.

On a typical security system, the number of user modes and security components may be sufficiently large that the size of the security management and/or control information may require large amounts of memory. There may be a significant number of access control entries that may correspond to instances when access rights may not be granted and/or instances when the access rights may be the same for multiple user modes and/or for multiple security components, such as default settings, for example. The addition or removal of user modes or security components may pose various implementation challenges, which may increase hardware and/or software complexity. As software and/or hardware complexity increases, it may become more challenging to manage security operations without introducing security breaches or other concerns.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for using multiple memory regions for redundant remapping, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for using multiple memory regions for redundant remapping, in accordance with an embodiment of the invention.

FIG. 2A is a block diagram that illustrates exemplary mapping of on-chip memory into a plurality of memory regions, in accordance with an embodiment of the invention.

FIG. 2B is a block diagram that illustrates exemplary on-chip redundant remapping of memory regions, in accordance with an embodiment of the invention.

FIG. 2C is a block diagram illustrating exemplary division of memory rows based on a probability of error, in accordance with an embodiment of the invention.

FIG. 3 is a flowchart illustrating exemplary steps for redundant remapping of memory regions, in accordance with an embodiment of the invention.

### DETAILED DESCRIPTION OF THE INVENTION

Certain embodiments of the invention may be found in a method and system for using multiple memory regions for redundant remapping. Certain aspects of the invention may include dividing at least a portion of on-chip memory into a plurality of memory regions. Each of the plurality of memory regions may be mapped into a corresponding plurality of redundant memory regions, wherein if an error is detected in at least one of the plurality of memory regions, at least one of the plurality of memory regions having the detected error may be remapped to at least one of the corresponding plurality of redundant memory regions.

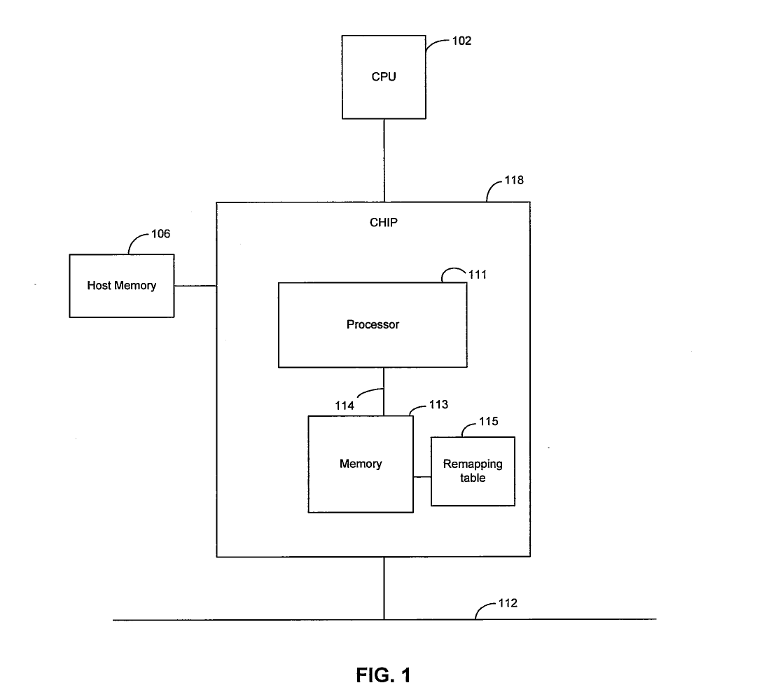

FIG. 1 is a block diagram of an exemplary system for using multiple memory regions for redundant remapping, in accordance with an embodiment of the invention. Referring to FIG. 1, there is shown a CPU 102, a host memory 106, a dedicated memory 116 and a chip 118. The chip 118 may comprise a memory controller 104, a processor 111, a memory 113, a replacement table 115, and a memory bus 114. The chip 118 may be coupled to the CPU 102, to the host memory 106, to the dedicated memory 116 and to a wired medium 112, for example, Ethernet. The chip 118 may be a network interface chip, for example. The dedicated memory 116 may provide buffers for context information and/or data. Although illustrated, for example, as a CPU and an Ethernet, the present invention need not be so limited to such examples and may employ, for example, any type of processor and any type of data link layer or physical media, respectively.

The processor 111 may comprise suitable logic, circuitry, and/or code that may be enabled to perform data processing and/or system control operations associated with the chip 118. The processor 111 may be enabled to perform multiple security operations on data received by the chip 118. The security operations may include, but need not be limited to, non-volatile memory (NVM) security, “key ladders,” which may be designed for cryptographically wrapping/unwrapping keys, challenge-response authentication, memory data signature verification, secure scrambler configuration, and security assurance logic, for example. In this regard, the processor 111 may comprise multiple security components to perform the features associated with the security operations. The processor 111 may be enabled to communicate with the memory 113 and the memory controller 110 via, for example, the memory bus 114. The memory 113 may comprise suitable logic, circuitry, and/or code that may be enabled to store data, control information, and/or operational information.

The processor 111 may be enabled to divide at least a portion of on-chip memory 113 into a plurality of memory regions. The processor 111 may enable mapping of each of the plurality of divided memory regions into a corresponding plurality of redundant memory regions. If an error is detected in at least one of the plurality of memory regions, the memory region having the detected error may be remapped to the corresponding redundant memory region. The processor 111 may be enabled to set an error flag associated with at least one of the plurality of memory regions having the detected error.

The processor 111 may be enabled to divide at least one of the plurality of memory regions into two or more rows. The processor 111 may be enabled to allocate at least one flag for each of the rows. The processor 111 may be enabled to set the allocated at least one flag associated with each of the rows having a detected error. The processor 111 may be enabled to allocate the plurality of memory regions and the corresponding plurality of redundant memory regions based on a predetermined plurality of address ranges. The remapping table 115 may be enabled to store the predetermined plurality of address ranges corresponding to the allocated plurality of memory regions and the corresponding plurality of redundant memory regions. The on-chip memory 113 may be least one or more of the following: a non-volatile memory, a secure flash electrically erasable programmable read only memory (EEPROM), and a flash RAM, for example. Notwithstanding, the invention may not be so limited, and other storage options may be utilized without departing from the scope of the invention.

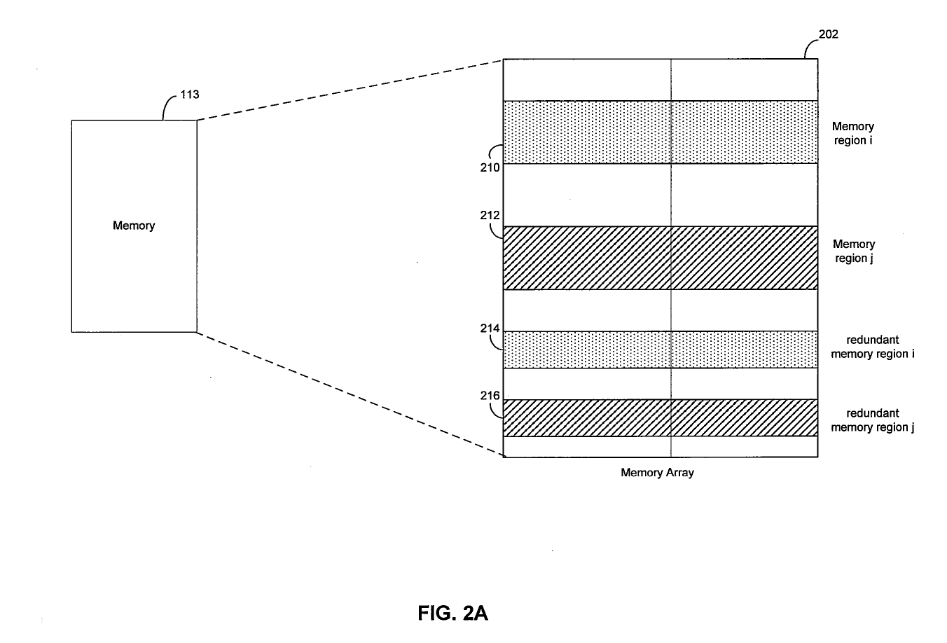

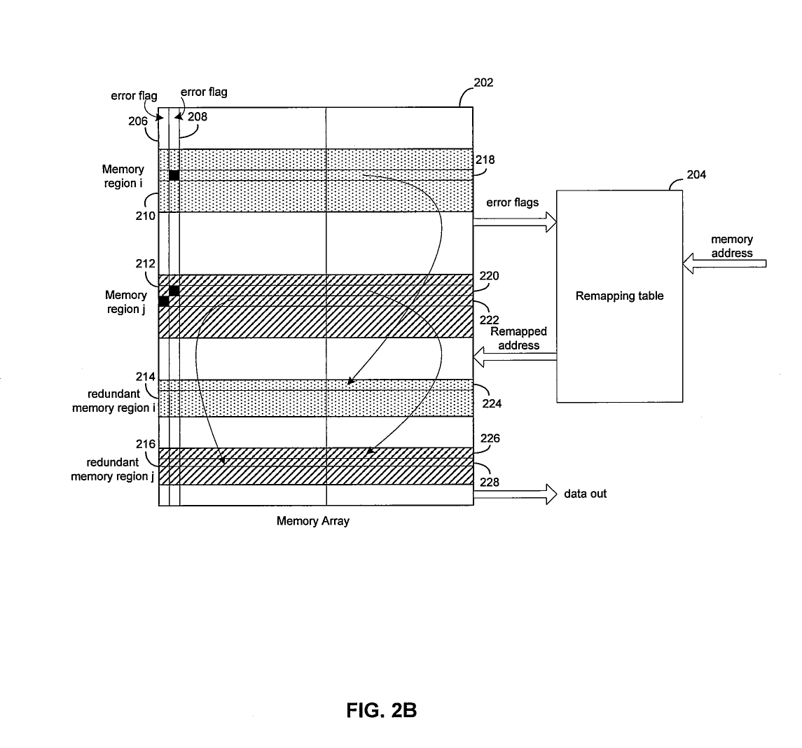

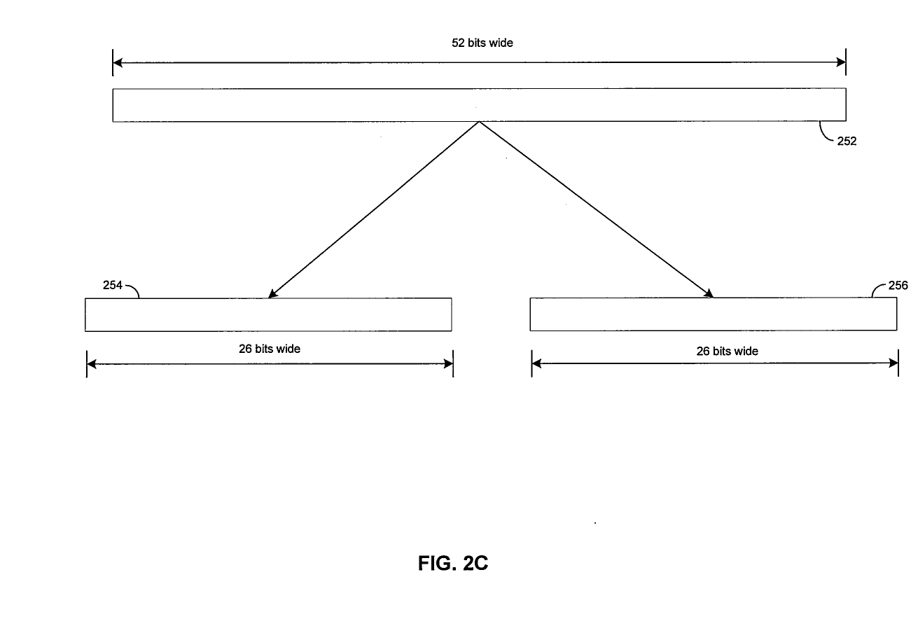

FIG. 2A is a block diagram that illustrates exemplary mapping of on-chip memory into a plurality of memory regions, in accordance with an embodiment of the invention. Referring to FIG. 2A, there is shown a memory 113 and a corresponding memory array 202. The memory array 202 may be divided into a plurality of memory regions, for example, memory region i 210 and memory region j 212. Each of the plurality of memory regions, for example, memory region i 210 and memory region j 212 may be mapped into a corresponding plurality of redundant memory regions, for example, redundant memory region i 214 and redundant memory region j 216 respectively.

FIG. 2B is a block diagram that illustrates exemplary on-chip redundant remapping of memory regions, in accordance with an embodiment of the invention. Referring to FIG. 2B, there is shown a memory array 202, and a replacement table 204. The memory array 202 may be divided into a plurality of memory regions, for example, memory region i 210 and memory region j 212. Each of the plurality of memory regions, for example, memory region i 210 and memory region j 212 may be mapped into a corresponding plurality of redundant memory regions, for example, redundant memory region i 214 and redundant memory region j 216 respectively.

An error flag, for example, error flag 206 or error flag 208 may be associated with at least one of the plurality of memory regions, for example, memory region i 210 and/or memory region j 212 having the detected error. For example, if the memory region i 210 has a detected error, the error flag 206 associated with the memory region i 210 may be set. At least one of the plurality of memory regions, for example, memory region i 210 and/or memory region j 212, having the detected error may be remapped to the corresponding redundant memory region, for example, redundant memory region i 214 and redundant memory region j 216 respectively, if the error flag, for example, error flag 206 or error flag 208 associated with at least one of the plurality of memory regions, for example, memory region i 210 and/or memory region j 212 having the detected error is set.

The plurality of memory regions, for example, memory region i 210 and/or memory region j 212 may be divided into two or more rows. For example, memory region j 212 may be divided into two or more rows, 220 and 222. Similarly, memory region i 210 may be divided into a plurality of rows, for example, row 218. At least one flag, for example, error flag 206 or error flag 208, may be allocated associated with each of the divided plurality of memory regions, for example, memory region i 210 and/or memory region j 212 having a detected error. For example, error flag 206 may be associated with row 218 in memory region i 210. For example, error flag 208 may be associated with row 220 in memory region j 212. The allocated error flags, for example, error flag 206 or error flag 208, associated with each of the divided plurality of memory regions, for example, memory region i 210 and/or memory region j 212 having a detected error may be set. For example, if row 218 in memory region i 210 has a detected error, the error flag 206 may be set. Similarly, if row 220 or row 222 in memory region j 212 has a detected error, the corresponding error flag 206 and/or 208 may be set.

In another embodiment of the invention, if a particular row within a memory region has a detected error, the particular row may be remapped into a corresponding row within the corresponding redundant memory region. For example, if row 218 within memory region i 210 has a detected error, the particular row 218 may be remapped into the corresponding row 224 within the corresponding redundant memory region i 214. Similarly, if row 220 within memory region j 212 has a detected error, the particular row 220 may be remapped into the corresponding row 226 within the corresponding redundant memory region j 216. Similarly, if row 222 within memory region j 212 has a detected error, the particular row 222 may be remapped into the corresponding row 228 within the corresponding redundant memory region j 216.

The remapping table 204 may comprise suitable logic, circuitry, and/or code that may be enabled to store a predetermined plurality of address ranges corresponding to the allocated plurality of memory regions, for example, memory region i 210 and/or memory region j 212. The plurality of memory regions, for example, memory region i 210 and/or memory region j 212 may be allocated based on the predetermined plurality of address ranges. The predetermined address ranges may comprise, for example, 10 data rows per memory region. The plurality of allocated address ranges may be predetermined based on, for example, statistical data collected from production wafers. For example, it may be determined that approximately 0.5% of data bits may be in error in the memory 113, for example. The probability of error may be utilized to determine the amount of memory space to be allocated to a redundant memory region.

A plurality of redundant memory regions may be accessible for remapping the rows in the memory regions with error bits based on the predetermined plurality of address ranges. The remapping table 204 may be enabled to store the predetermined plurality of address ranges corresponding to the allocated plurality of memory regions, for example, memory region i 210 and/or memory region j 212 and the corresponding plurality of redundant memory regions, for example, redundant memory region i 214 and redundant memory region j 216 respectively based on the predetermined plurality of address ranges. The remapping table 204 may be utilized for remapping rows and memory regions. The remapping table 204 may also be utilized for looking up any of the memory regions based on their corresponding address ranges.

In accordance with an embodiment of the invention, the plurality of memory regions, for example, memory region i 210 and memory region j 212 may be mapped into a corresponding plurality of redundant memory regions, for example, redundant memory region i 214 and redundant memory region j 216 respectively to allow a user to program memory regions or particular rows within memory regions after production programming and utilize the redundant memory regions or particular rows within memory regions, if an error is detected within the memory regions. The number of redundant rows that may be utilized may not be known after programming as the number of rows having a detected error may affect the number of redundant rows utilized.

FIG. 2C is a block diagram illustrating exemplary division of memory rows based on a probability of error, in accordance with an embodiment of the invention. Referring to FIG. 2C, there is shown a 52-bit memory row 252 within the memory 113 that may be divided into two 26-bit memory rows, 254 and 256 respectively. Notwithstanding, the invention may not be limited in this regard, and the length of the memory row may be suitably chosen.

Various embodiments of the invention may utilize more than one error flag per row within a memory region. For example, the 52-bit row 252 may have a higher probability of an error and may exceed the number of redundant rows available. In another embodiment of the invention, the plurality of memory regions, for example, memory region i 210 and/or memory region j 212 may be divided into two or more rows. For example, the 52-bit row 252 may be divided into two 26-bit rows, 254 and 256, which may result in doubling the redundant rows available for remapping. An error flag may be utilized to indicate the presence of an error for each of the 26 bit rows. For example, error flag 206 may be set, if an error is detected within the row 220. Similarly, the error flag 208 may be set, if an error is detected within the row 222.

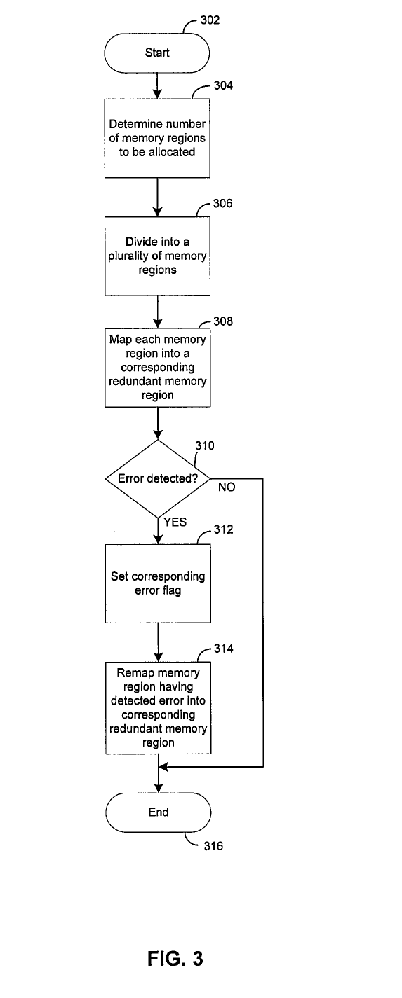

FIG. 3 is a flowchart illustrating exemplary steps for redundant remapping of memory regions, in accordance with an embodiment of the invention. Referring to FIG. 3, exemplary steps may begin at step 302. In step 304, the number of redundant memory regions to be allocated may be determined based on a predetermined set of address ranges. In step 306, the memory array 202 may be divided into a plurality of memory regions, for example, memory region i 210 and memory region j 212 based on the predetermined set of address ranges. In step 308, each of the plurality of memory regions, for example, memory region i 210 and memory region j 212 may be mapped into a corresponding plurality of redundant memory regions, for example, redundant memory region i 214 and redundant memory region j 216 respectively.

In step 310, it may be determined whether an error is detected within at least one of the plurality of memory regions. If an error is not detected within at least one of the plurality of memory regions, control passes to end step 316. If an error is detected within at least one of the plurality of memory regions, control passes to 312. In step 312, an error flag, for example, error flag 206 associated with a particular memory region, for example, memory region i 210 having the detected error may be set. In step 314, the particular memory region, for example, memory region i 210 having the detected error may be remapped to the corresponding redundant memory region, for example, redundant memory region i 214. In another embodiment of the invention, if a particular row within a memory region has a detected error, the particular row may be remapped into a corresponding row within the corresponding redundant memory region. For example, if row 218 within memory region i 210 has a detected error, the particular row 218 may be remapped into the corresponding row 224 within the corresponding redundant memory region i 214. Control then passes to end step 316.

In accordance with an embodiment of the invention, a method and system for using multiple memory regions for redundant remapping may comprise a processor 111 that enables dividing at least a portion of on-chip memory 113 into a plurality of memory regions, for example, memory region i 210 and memory region j 212. The processor 111 may enable mapping of each of the plurality of memory regions, for example, memory region i 210 and memory region j 212 into a corresponding plurality of redundant memory regions, for example, redundant memory region i 214 and redundant memory region j 216 respectively. If an error is detected in at least one of plurality of memory regions, for example, memory region i 210 and/or memory region j 212, the memory region having the detected error may be remapped to the corresponding redundant memory region. The processor 111 may be enabled to set an error flag, for example, error flag 206 or error flag 208 associated with at least one of the plurality of memory regions having the detected error. For example, if the memory region i 210 has a detected error, the error flag 206 associated with the memory region i 210 may be set.

The processor 111 may be enabled to divide at least one of the plurality of memory regions, for example, memory region i 210 and/or memory region j 212 into two or more rows. For example, memory region j 212 may be divided into two or more rows, 220 and 222. The processor 111 may be enabled to allocate at least one flag, for example, error flag 206 or error flag 208, associated with each of the divided plurality of memory regions, for example, memory region i 210 and/or memory region j 212 having a detected error. The processor 111 may be enabled to set the allocated at least one flag, for example, error flag 206 or error flag 208, associated with each of the divided plurality of memory regions, for example, memory region i 210 and/or memory region j 212 having a detected error. The processor 111 may be enabled to allocate the plurality of memory regions, for example, memory region i 210 and/or memory region j 212 based on a predetermined plurality of address ranges.

The remapping table 204 may be enabled to store the predetermined plurality of address ranges corresponding to the allocated plurality of memory regions, for example, memory region i 210 and/or memory region j 212. The processor 111 may be enabled to allocate the corresponding plurality of redundant memory regions, for example, redundant memory region i 214 and redundant memory region j 216 respectively based on a predetermined plurality of address ranges. The remapping table 204 may be enabled to store the predetermined plurality of address ranges corresponding to the allocated corresponding plurality of redundant memory regions, for example, redundant memory region i 214 and redundant memory region j 216 respectively. The on-chip memory 113 may be least one or more of the following: a non-volatile memory, a secure flash electrically erasable programmable read only memory (EEPROM), and a flash RAM, for example. Notwithstanding, the invention may not be so limited, and other storage options may be utilized without departing from the scope of the invention.

Another embodiment of the invention may provide a machine-readable storage, having stored thereon, a computer program having at least one code section executable by a machine, thereby causing the machine to perform the steps as described above for using multiple memory regions for redundant remapping.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing information in a communication system, the method comprising:
dividing at least a portion of on-chip memory into a plurality of memory regions;
mapping each of said plurality of memory regions into a corresponding plurality of redundant memory regions, wherein if an error is detected in at least one of said plurality of memory regions, said at least one of said plurality of memory regions having said detected error is remapped to at least one of said corresponding plurality of redundant memory regions.

2. The method according to claim 1, comprising setting an error flag associated with at least one of said plurality of memory regions having said detected error.

3. The method according to claim 1, comprising dividing at least one of said plurality of memory regions into two or more rows.

4. The method according to claim 3, comprising allocating at least one flag associated with each of said divided said at least one of said plurality of memory regions having said detected error.

5. The method according to claim 4, comprising setting said allocated said at least one flag associated with each of said divided said at least one of said plurality of memory regions having said detected error.

6. The method according to claim 1, comprising allocating said plurality of memory regions based on a predetermined plurality of address ranges.

7. The method according to claim 6, comprising storing said predetermined plurality of address ranges corresponding to said allocated said plurality of memory regions.

8. The method according to claim 1, comprising allocating said corresponding plurality of redundant memory regions based on a predetermined plurality of address ranges.

9. The method according to claim 8, comprising storing said predetermined plurality of address ranges corresponding to said allocated said corresponding plurality of redundant memory regions.

10. The method according to claim 1, wherein said on-chip memory is at least one or more of the following: a non-volatile memory, a secure flash electrically erasable programmable read only memory (EEPROM), and a flash RAM.

11. A machine-readable storage having stored thereon, a computer program having at least one code section for processing information in a communication system, the at least one code section being executable by a machine for causing the machine to perform steps comprising:
dividing at least a portion of on-chip memory into a plurality of memory regions;
mapping each of said plurality of memory regions into a corresponding plurality of redundant memory regions, wherein if an error is detected in at least one of said plurality of memory regions, said at least one of said plurality of memory regions having said detected error is remapped to at least one of said corresponding plurality of redundant memory regions.

12. The machine-readable storage according to claim 11, wherein said at least one code section comprises code for setting an error flag associated with at least one of said plurality of memory regions having said detected error.

13. The machine-readable storage according to claim 11, wherein said at least one code section comprises code for dividing at least one of said plurality of memory regions into two or more rows.

14. The machine-readable storage according to claim 13, wherein said at least one code section comprises code for allocating at least one flag associated with each of said divided said at least one of said plurality of memory regions having said detected error.

15. The machine-readable storage according to claim 14, wherein said at least one code section comprises code for setting said allocated said at least one flag associated with each of said divided said at least one of said plurality of memory regions having said detected error.

16. The machine-readable storage according to claim 11, wherein said at least one code section comprises code for allocating said plurality of memory regions based on a predetermined plurality of address ranges.

17. The machine-readable storage according to claim 16, wherein said at least one code section comprises code for storing said predetermined plurality of address ranges corresponding to said allocated said plurality of memory regions.

18. The machine-readable storage according to claim 11, wherein said at least one code section comprises code for allocating said corresponding plurality of redundant memory regions based on a predetermined plurality of address ranges.

19. The machine-readable storage according to claim 18, wherein said at least one code section comprises code for storing said predetermined plurality of address ranges corresponding to said allocated said corresponding plurality of redundant memory regions.

20. The machine-readable storage according to claim 11, wherein said on-chip memory is at least one or more of the following: a non-volatile memory, a secure flash electrically erasable programmable read only memory (EEPROM), and a flash RAM.

21. A system for processing information in a communication system, the system comprising:
one or more circuits that enables dividing at least a portion of on-chip memory into a plurality of memory regions;
said one or more circuits enables mapping of each of said plurality of memory regions into a corresponding plurality of redundant memory regions, wherein if an error is detected in at least one of said plurality of memory regions, said at least one of said plurality of memory regions having said detected error is remapped to at least one of said corresponding plurality of redundant memory regions.

22. The system according to claim 21, wherein said one or more circuits enables setting of an error flag associated with at least one of said plurality of memory regions having said detected error.

23. The system according to claim 21, wherein said one or more circuits enables division of at least one of said plurality of memory regions into two or more rows.

24. The system according to claim 23, wherein said one or more circuits enables allocation of at least one flag associated with each of said divided said at least one of said plurality of memory regions having a detected error.

25. The system according to claim 24, wherein said one or more circuits enables setting of said allocated said at least one flag associated with each of said divided said at least one of said plurality of memory regions having a detected error.

26. The system according to claim 21, wherein said one or more circuits enables allocation of said plurality of memory regions based on a predetermined plurality of address ranges.

27. The system according to claim 26, wherein said one or more circuits enables storage of said predetermined plurality of address ranges corresponding to said allocated said plurality of memory regions.

28. The system according to claim 21, wherein said one or more circuits enables allocation of said corresponding plurality of redundant memory regions based on a predetermined plurality of address ranges.

29. The system according to claim 28, wherein said one or more circuits enables storage of said predetermined plurality of address ranges corresponding to said allocated said corresponding plurality of redundant memory regions.

30. The system according to claim 21, wherein said on-chip memory is at least one or more of the following: a non-volatile memory, a secure flash electrically erasable programmable read only memory (EEPROM), and a flash RAM.

31. The system according to claim 21, wherein said one or more circuits comprises a processor.
